(19) United States
(12) Patent Application Publication
(10) Pub. No.: US 2025/0162493 A1
(43) Pub. Date: May 22, 2025

(54) VEHICLE POSTURE CALCULATION DEVICE AND HEADLIGHT OPTICAL AXIS CONTROL DEVICE

(71) Applicant: TOYOTA JIDOSHA KABUSHIKI KAISHA, Toyota-shi (JP)

(72) Inventor: Tatsuya Ochi, Toyota-shi (JP)

(73) Assignee: TOYOTA JIDOSHA KABUSHIKI KAISHA, Toyota-shi (JP)

(21) Appl. No.: 18/923,072

(22) Filed: Oct. 22, 2024

(30) Foreign Application Priority Data
Nov. 17, 2023 (JP) 2023-195678

(51) Int. Cl. B60Q 1/10; G01P 15/18

(52) U.S. Cl. CPC B60Q 1/10; G01P 15/18

(57) ABSTRACT

A vehicle posture calculation device calculates a posture of a vehicle using an acceleration sensor. The vehicle posture calculation device calculates a sensor detection angle, which is a rotation angle around an axis along a vehicle width direction relative to a horizontal plane, based on a detection result of the acceleration sensor. If the position of the vehicle changes between ignition off and ignition on, it detects the change in the sensor detection angle between ignition off and ignition on as a change in the road surface angle. If a position of the vehicle does not change, it detects the change in the sensor detection angle between ignition off and ignition on as a change in the pitch angle of the vehicle.

### TECHNICAL FIELD

The present disclosure relates to a vehicle posture calculation device and a headlight optical axis control device.

### BACKGROUND

A vehicle posture calculation device that calculates a posture of a vehicle using an acceleration sensor is known. As an example of such technology, Japanese Patent Application Laid-Open No. 2021-062866 discloses a device that calculates a rotation angle around an axis along the vehicle width direction relative to the horizontal plane (hereinafter referred to as “sensor detection angle”) based on a detection results of the acceleration sensor.

### SUMMARY

In the device described above, it is assumed that the road surface angle does not change while the ignition is off, and changes in the sensor detection angle while the ignition is off may be detected as changes in pitch angle of the vehicle (the rotation angle around an axis along the vehicle width direction relative to the road surface). However, in this case, for example, if the vehicle is transported by a trailer or ship while the ignition is off and the road surface angle changes, there is a possibility of erroneously detecting this change in the road surface angle as a change in the pitch angle.

Therefore, the present disclosure aims to provide a vehicle posture calculation device and a headlight optical axis control device that can suppress erroneous detection of changes in the road surface angle as changes in the pitch angle.

A vehicle posture calculation device according to one aspect of the present disclosure is a vehicle posture calculation device that calculates a posture of a vehicle using an acceleration sensor. Based on a detection results of the acceleration sensor, it calculates a sensor detection angle, which is a rotation angle around an axis along a vehicle width direction relative to a horizontal plane. If the position changes of a vehicle between ignition off and ignition on, it detects a change in the sensor detection angle between ignition off and ignition on as a change in a road surface angle. If the position of the vehicle does not change between ignition off and ignition on, it detects a change in the sensor detection angle between ignition off and ignition on as a change in a pitch angle of the vehicle.

The vehicle posture calculation device according to one aspect of the present disclosure may determine whether the position of the vehicke has changed based on a position information of the vehicle obtained using GPS or a camera image obtained by a camera that captures a surroundings of the vehicle.

A headlight optical axis control device according to one aspect of the present disclosure includes the above vehicle posture calculation device and may adjust an optical axis of a headlight of vicle in accordance with according to the change in the pitch angle of a hertre detected by the vehicle posture calculation device.

According to various aspects of the present disclosure, it is possible to provide a vehicle posture calculation device and a headlight optical axis control device that can suppress erroneous detection of changes in the road surface angle as changes in the pitch angle.

### BRIEF DESCRIPTION OF THE DRAWINGS

FIG. 1 is a block diagram showing the configuration of a vehicle posture calculation device and a headlight optical axis control device according to an embodiment.

FIG. 2 is a diagram explaining the sensor detection angle, pitch angle, and road surface angle.

FIG. 3A is a flowchart showing the processing when the ignition is off in the vehicle posture calculation device of FIG. 1. FIG. 3B is a flowchart showing the processing when the ignition is on in the vehicle posture calculation device of FIG. 1.

FIG. 4A is a flowchart showing another processing when the ignition is off in the vehicle posture calculation device of FIG. 1. FIG. 4B is a flowchart showing another processing when the ignition is on in the vehicle posture calculation device of FIG. 1.

### DETAILED DESCRIPTION

Hereinafter, embodiments will be described in detail with reference to the accompanying drawings. In the description of the drawings, the same or equivalent elements are denoted by the same reference numerals, and redundant explanations are omitted.

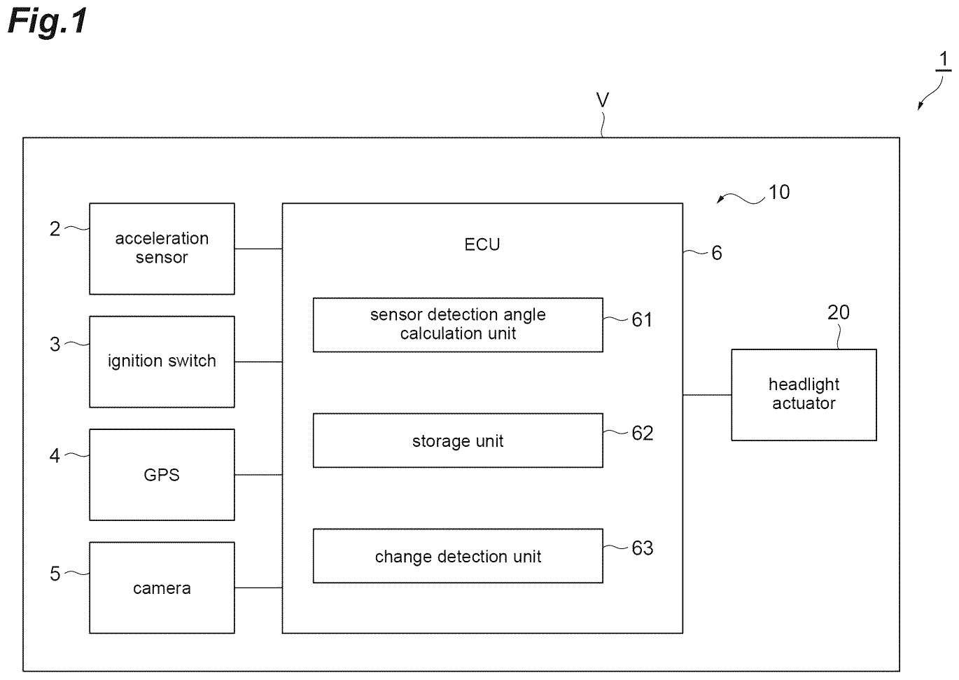

As shown in FIG. 1, a headlight optical axis control device 1 according to the embodiment is a device that controls an optical axis of the headlight of a vehicle V. The vehicle V may be a passenger car or a truck. The vehicle V can accommodate one or more occupants. The vehicle V may be an autonomous driving vehicle capable of autonomous driving. The vehicle V may also be capable of manual driving by a driver. The headlight is a lamp that illuminates the front of the vehicle V. The headlight is configured such that its optical axis (the direction of the light emitted by the headlight) can be adjusted. The headlight is not particularly limited and various known headlights may be used.

The headlight optical axis control device 1 includes a vehicle posture calculation device 10 and a headlight actuator 20. The vehicle posture calculation device 10 is a device that calculates a posture of the vehicle V using an acceleration sensor 2. The vehicle posture calculation device 10 here can calculate the change in the pitch angle θv of the vehicle V, which will be described later. The vehicle posture calculation device includes an acceleration sensor 2, an ignition switch 3, a GPS (Global Positioning System) 4, a camera 5, and an ECU (Electronic Control Unit) 6.

The acceleration sensor 2 detects the longitudinal acceleration, which is the acceleration in the front-rear direction of the vehicle V, and the vertical acceleration, which is the acceleration in the up-down direction of the vehicle V. The acceleration sensor 2 is not particularly limited and various known sensors may be used. The acceleration sensor 2 transmits information regarding the detected longitudinal acceleration and vertical acceleration to the ECU 6.

The ignition switch 3 is a switch for starting and stopping the power source and the like of the vehicle V. The ignition switch 3 is not particularly limited and various known devices may be used. When the ignition switch 3 is turned on, information regarding the ignition on is transmitted to the ECU 6. Also, when the ignition switch 3 is turned off, information regarding the ignition off is transmitted to the ECU 6.

The GPS 4 measures the current location of the vehicle V by receiving signals from three or more GPS satellites. The current location of the vehicle V is the current position of the vehicle V (the place where the vehicle V currently exists), and is represented, for example, by latitude and longitude. The GPS 4 transmits the current location information (position information) regarding the measured current location of the vehicle V to the ECU 6. The camera 5 captures images of the surroundings of the vehicle V. The camera 5 is not particularly limited and various known imaging devices may be used. The camera 5 transmits the obtained camera images to the ECU 6.

The ECU 6 is an electronic control unit having a CPU (Central Processing Unit), ROM (Read Only Memory), RAM (Random Access Memory), and the like. In the ECU 6, for example, various functions are realized by loading a program stored in the ROM into the RAM and executing the program loaded into the RAM by the CPU. Some of the functions of the ECU 6 may be executed on a server that can communicate with the vehicle V. The ECU 6 may be composed of multiple electronic units.

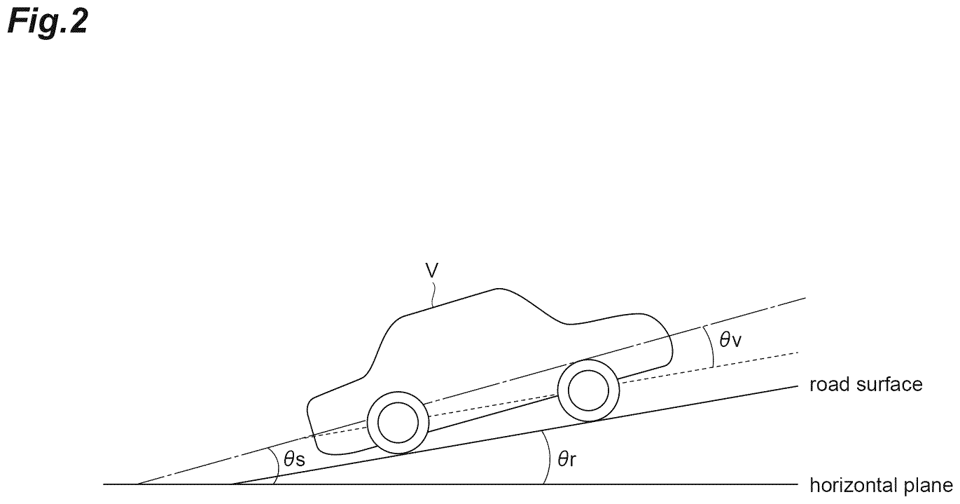

The ECU 6 has, as a functional configuration, a sensor detection angle calculation unit 61, a storage unit 62, and a change detection unit 63. The sensor detection angle calculation unit 61 calculates the sensor detection angle θs based on the detection result of the acceleration sensor 2. As shown in FIG. 2, the sensor detection angle θs is the rotation angle around the axis along the vehicle width direction of the vehicle V with respect to the horizontal plane. The sensor detection angle θs is composed of the sum (composite angle) of the pitch angle θv of the vehicle V and the road surface angle θr, as shown in the following equation (1). The pitch angle θv is the rotation angle around the axis along the vehicle width direction of the vehicle V with respect to the road surface. The road surface angle θr is the rotation angle around the axis along the vehicle width direction of the road surface with respect to the horizontal plane.

$$Sensor detection angle θ s = pitch angle θ v + road surface angle θ r \qquad ( 1 )$$

The sensor detection angle calculation unit 61 calculates the sensor detection angle θs using the longitudinal acceleration and the vertical acceleration. Specifically, the sensor detection angle calculation unit 61 calculates the sensor detection angle θs according to the following equation (2).

$$Sensor detection angle θ s = tan \hat{} - 1 ( longitudinal acceleration / vertical acceleration ) \qquad ( 2 )$$

The storage unit 62 stores the current location information, camera images, and sensor detection angle θs at the time of ignition off. The change detection unit 63 determines whether the current location of the vehicle V has changed from ignition off to ignition on based on the current location information obtained using the GPS 4.

Specifically, the change detection unit 63 compares the current location information at the time of ignition on with the current location information stored in the storage unit 62. If the two match, the change detection unit 63 determines that the current location of the vehicle V has not changed from ignition off to ignition on, and if the two do not match, the change detection unit 63 determines that the current location of the vehicle V has changed from ignition off to ignition on. Various known methods can be used to determine the match/mismatch of the current location information. The match includes approximate matches.

If the current location of the vehicle V has changed from ignition off to ignition on, the change detection unit 63 detects the change in the sensor detection angle θs from ignition off to ignition on as a change in the road surface angle θr. If the current location of the vehicle V has not changed from ignition off to ignition on, the change detection unit 63 detects the change in the sensor detection angle θs from ignition off to ignition on as a change in the pitch angle θv.

The headlight actuator 20 is an actuator that adjusts the optical axis of the headlight. The headlight actuator 20 is not particularly limited and various known actuators may be used. The headlight actuator 20 is controlled by the ECU 6 and adjusts the optical axis of the headlight of the vehicle V according to the change in the pitch angle θv detected by the change detection unit 63. For example, the headlight actuator 20 is controlled by the ECU 6 using a data table that associates the pitch angle θv with the drive amount of the headlight actuator 20, and adjusts the optical axis of the headlight according to the change in the pitch angle θv.

Next, the processing in the vehicle posture calculation device 10 will be described.

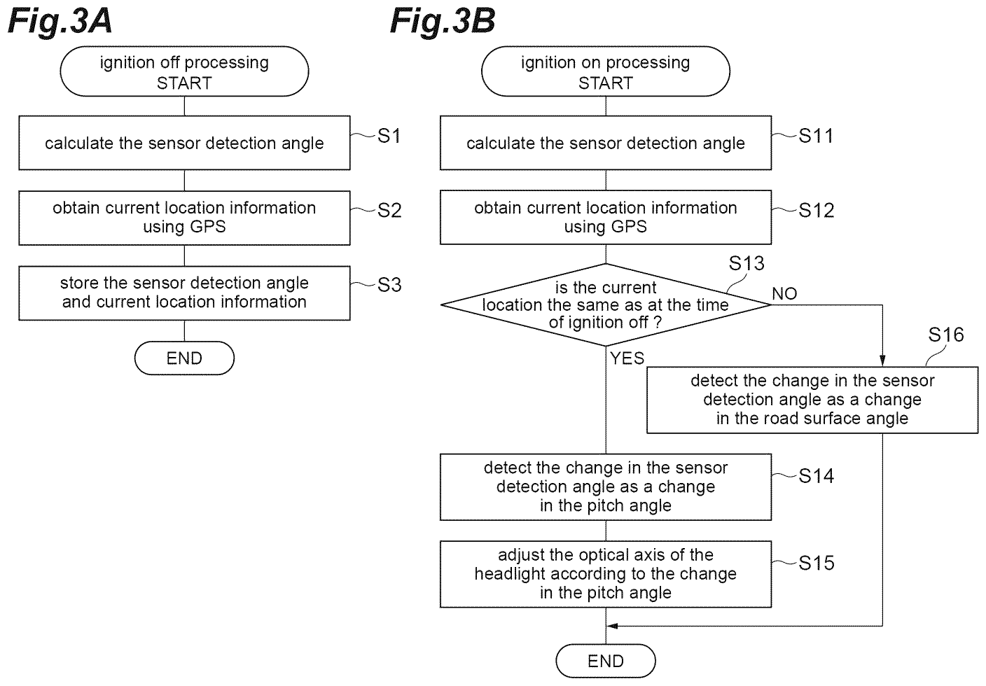

FIG. 3A is a flowchart showing the processing at the time of ignition off. When the ignition off is performed, the vehicle posture calculation device 10 executes the following processing. As shown in FIG. 3A, first, the sensor detection angle calculation unit 61 calculates the sensor detection angle θs based on the detection result of the acceleration sensor 2 (step S1). The current location information is obtained using the GPS 4 (step S2). The calculated sensor detection angle θs and the obtained current location information are stored in the storage unit 62 (step S3). Thereafter, the processing at the time of ignition off is completed.

FIG. 3B is a flowchart showing the processing at the time of ignition on. When the ignition on is performed after the processing at the time of ignition off in FIG. 3A, the vehicle posture calculation device 10 executes the following processing. As shown in FIG. 3B, first, the sensor detection angle calculation unit 61 calculates the sensor detection angle θs based on the detection result of the acceleration sensor 2 (step S11). The current location information is obtained using the GPS 4 (step S12).

The change detection unit 63 compares the current location information obtained in step S12 with the current location information stored in the storage unit 62 and determines whether they match (step S13). If YES in step S13, the change detection unit 63 determines that the current location is the same as at the time of ignition off, that is, the current location of the vehicle V has not changed from ignition off to ignition on, and detects the change in the sensor detection angle θs as a change in the pitch angle θv (step S14). Then, the headlight actuator 20 adjusts the optical axis of the headlight according to the change in the pitch angle θv (step S15). Thereafter, the processing at the time of ignition on is completed.

On the other hand, if NO in step S13, the change detection unit 63 determines that the current location is different from the time of ignition off, that is, the current location of the vehicle V has changed from ignition off to ignition on, and detects the change in the sensor detection angle θs as a change in the road surface angle θr (step S16). Thereafter, the processing at the time of ignition on is completed.

As described above, in the vehicle posture calculation device 10, when the road surface angle θr changes due to transportation by a trailer or ship, for example, between ignition off and ignition on, it is possible to suppress the erroneous detection of the change in the road surface angle θr as a change in the pitch angle θv.

In the vehicle posture calculation device 10, it is determined whether the current location of the vehicle V has changed based on the current location information obtained using the GPS 4. In this case, complex calculations are not required, and the processing can be simplified.

Since the headlight optical axis control device 1 includes the vehicle posture calculation device 10, it is possible to suppress the erroneous detection of the change in the road surface angle θr as a change in the pitch angle θv, as described above. It becomes possible to appropriately control the optical axis of the headlight.

In the present embodiment, the change detection unit 63 determines whether the current location of the vehicle V has changed based on the current location information, but instead of or in addition to this, it may determine whether the current location of the vehicle V has changed based on the camera images obtained by the camera 5.

Specifically, the change detection unit 63 compares the camera images at the time of ignition on with the camera images stored in the storage unit 62, and if the two match, it determines that the current location of the vehicle V has not changed from ignition off to ignition on, and if the two do not match, it determines that the current location of the vehicle V has changed from ignition off to ignition on. When determining whether the current location of the vehicle V has changed based on the camera images, the vehicle posture calculation device 10 executes the following processing, for example.

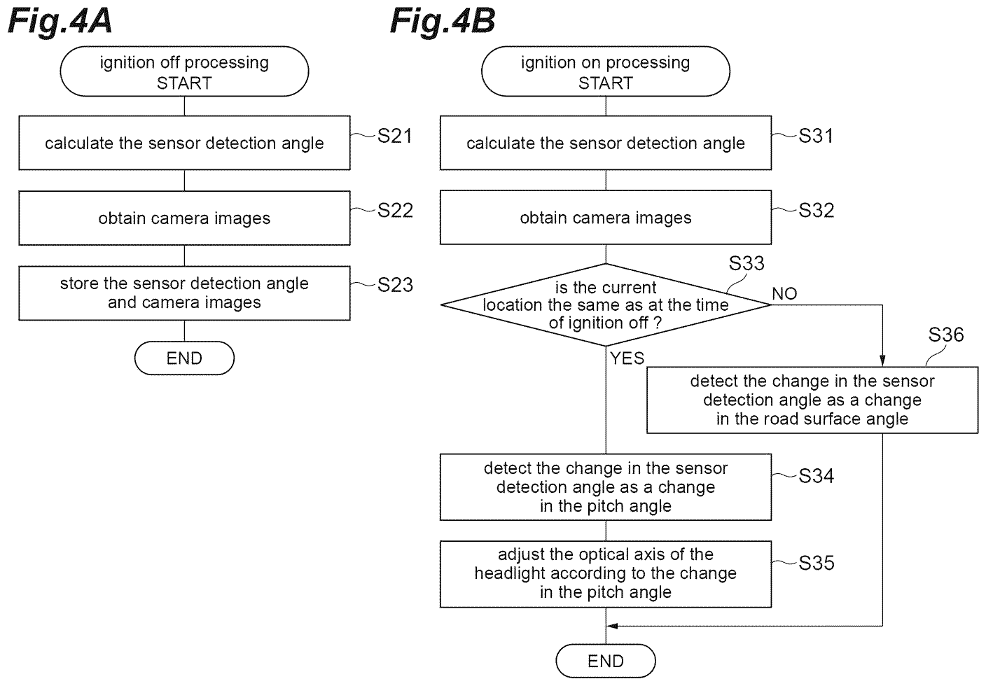

When the ignition off is performed, as shown in FIG. 4A, first, the sensor detection angle calculation unit 61 calculates the sensor detection angle θs based on the detection result of the acceleration sensor 2 (step S21). The camera image is obtained by the camera 5 (step S22). The calculated sensor detection angle θs and the obtained camera image are stored in the storage unit 62 (step S23). Thereafter, the processing at the time of ignition off is completed.

When the ignition on is performed after the processing at the time of ignition off in FIG. 4A, as shown in FIG. 4B, first, the sensor detection angle calculation unit 61 calculates the sensor detection angle θs based on the detection result of the acceleration sensor 2 (step S31). The camera image is obtained by the camera 5 (step S32). The change detection unit 63 compares the camera image obtained in step S32 with the camera image stored in the storage unit 62 and determines whether they match (step S33).

If YES in step S33, the change detection unit 63 determines that the current location is the same as at the time of ignition off, that is, the current location of the vehicle V has not changed from ignition off to ignition on, and detects the change in the sensor detection angle θs as a change in the pitch angle θv (step S34). Then, the headlight actuator 20 adjusts the optical axis of the headlight according to the change in the pitch angle θv (step S35). Thereafter, the processing at the time of ignition on is completed.

On the other hand, if NO in step S33, the change detection unit 63 determines that the current location is different from the time of ignition off, that is, the current location of the vehicle V has changed from ignition off to ignition on, and detects the change in the sensor detection angle θs as a change in the road surface angle θr (step S36). Thereafter, the processing at the time of ignition on is completed. When determining whether the current location of the vehicle V has changed based on the camera images, complex calculations are not required, and the processing can be simplified.

Although the embodiments have been described above, an aspect of the present disclosure is not limited to the above embodiments. An aspect of the present disclosure can be implemented in various forms with various modifications and improvements based on the knowledge of those skilled in the art, including but not limited to the above embodiments.

In the above embodiment, when determining whether the current location of the vehicle V has changed based only on the current location information, the camera 5 (camera image acquisition) and the processes in FIGS. 4A and 4B are unnecessary. In the above embodiment, when determining whether the current location of the vehicle V has changed based only on the camera images, the GPS 4 and the processes in FIGS. 3A and 3B are unnecessary.

In the above embodiment and the above modification, it is determined whether the current location of the vehicle V has changed, but instead of or in addition to this, it may be determined whether the orientation (travel direction) of the vehicle V has changed. Specifically, the vehicle posture calculation device 10 detects the change in the sensor detection angle θs from ignition off to ignition on as a change in the road surface angle θr when the position and/or orientation of the vehicle V has changed from ignition off to ignition on, and detects the change in the sensor detection angle θs from ignition off to ignition on as a change in the pitch angle θv when the position and/or orientation of the vehicle V has not changed from ignition off to ignition on. This makes it possible to suppress the erroneous detection of the change in the road surface angle θr as a change in the pitch angle θv when the orientation of the vehicle V has changed between ignition off and ignition on.

In the above embodiment and the above modification, when determining whether the current location and/or orientation of the vehicle V has changed based on both the current location information and the camera images, the determination may be made as follows. For example, when it is determined based on the current location information that the current location and/or orientation of the vehicle V has not changed, and it is also determined based on the camera images that the current location and/or orientation of the vehicle V has not changed, it may be finally determined that the current location and/or orientation of the vehicle V has not changed. Also, for example, when it is determined based on the current location information that the current location and/or orientation of the vehicle V has changed, and it is also determined based on the camera images that the current location and/or orientation of the vehicle V has changed, it may be finally determined that the current location and/or orientation of the vehicle V has changed.

Also, for example, when it is determined based on the current location information that the orientation of the vehicle V has not changed, but it is determined based on the camera images that the orientation of the vehicle V has changed, it may be finally determined that the orientation of the vehicle V has changed. Also, for example, when it is determined based on the current location information that the current location of the vehicle V has changed, but it is determined based on the camera images that the current location of the vehicle V has not changed, it may be finally determined that the current location of the vehicle V has changed.

What is claimed is:

1. A vehicle posture calculation device that calculates a posture of a vehicle using an acceleration sensor, comprising:
calculating a sensor detection angle, which is a rotation angle around an axis along a vehicle width direction relative to a horizontal plane, based on a detection result of the acceleration sensor;
detecting a change in the sensor detection angle between ignition off and ignition on as a change in a road surface angle if a position and/or orientation of the vehicle changes between ignition off and ignition on; and
detecting a change in the sensor detection angle between ignition off and ignition on as a change in a pitch angle of the vehicle if the position and/or orientation of the vehicle does not change between ignition off and ignition on.

2. The vehicle posture calculation device according to claim 1, wherein it determines whether the position of the vehicle has changed based on a position information of the vehicle obtained using GPS or a camera image obtained by a camera that captures a surroundings of the vehicle.

3. A headlight optical axis control device comprising the vehicle posture calculation device according to claim 1, wherein it adjusts an optical axis of a headlight of the vehicle in accordance with the change in the pitch angle of the vehicle detected by the vehicle posture calculation device.
